(19) United States
(12) Patent Application Publication
(10) Pub. No.: US 2023/0288896 A1
(43) Pub. Date: Sep. 14, 2023

(54) METHOD FOR PRODUCING TRANSMISSION COMPONENTS

(71) Applicant: MAGNA Powertrain GmbH & Co KG, Lannach (AT)

(72) Inventors: Ewald Dohr, St. Michael (AT); Karl Harb, Mooskirchen (AT)

(21) Appl. No.: 18/013,945

(22) PCT Filed: Jun. 10, 2021
(86) PCT No.: PCT/EP2021/065668

§ 371 Date: Dec. 30, 2022

(30) Foreign Application Priority Data
Jul. 6, 2020 (DE) 10 2020 208 444.0

(51) Int. Cl. G05B 19/042; G01M 13/028

(52) U.S. Cl. CPC G05B 19/0428; G01M 13/028

(57) ABSTRACT

A method for producing a plurality of transmission components of a transmission component type includes: manufacturing transmission components in a manufacturing machine, mounting at least one vibration sensor on the manufacturing machine, detecting vibrations during manufacture of the transmission components in the manufacturing machine by the vibration sensor, evaluating the detected vibrations in each case by a computer unit, classifying the transmission components in each case by the computer unit into one of at least two classes of the transmission component type depending on the detected vibrations.

### CROSS-REFERENCE TO RELATED APPLICATIONS

This application is a National Stage of International Application No. PCT/EP2021/065668, filed Jun. 10, 2021, which claims priority to DE 10 2020 208 444.0, filed Jul. 6, 2020. The entire disclosures of each of the above applications are incorporated herein by reference.

### FIELD

The present disclosure relates to a method for producing a plurality of transmission components of a transmission component type, in particular gearwheels.

### BACKGROUND

This section provides information related to the present disclosure which is not necessarily prior art.

Transmission components, such as gearwheels for transmissions, can be manufactured in large numbers in manufacturing machines, for example for automotive construction. The required components are thereby shaped in the manufacturing machine, for example by grinding.

Quality defects of the transmission components are conventionally detected in the course of further processing of the transmission components, in particular during quality checks of the individual component or after the transmission component has been installed in a transmission device, for example in a manual transmission or a transfer gearbox. In the worst case, defective components are detected only after complete manufacture of a vehicle or even only during operation of a vehicle equipped with the component.

The required quality of transmission components can be different in the case of installation, for example, in different transmission devices or at different positions within a transmission device, so that different quality levels of transmission components can be tolerable or not tolerable depending on the intended use.

### SUMMARY

This section provides a general summary of the disclosure and is not a comprehensive disclosure of its full scope or all of its features.

It is an object of the invention to provide a method for producing a plurality of transmission components of a transmission component type, wherein efficient manufacture and assurance of the required quality of the transmission components are to be ensured.

The object is achieved by a method for producing a plurality of transmission components of a transmission component type, wherein the transmission components are manufactured in a manufacturing machine, wherein at least one vibration sensor is mounted on the manufacturing machine, wherein vibrations during manufacture of the transmission components in the manufacturing machine are detected by way of the vibration sensor, wherein the detected vibrations are in each case evaluated by a computer unit, for example an industrial PC or a virtual machine, wherein the transmission components are in each case classified by the computer unit into one of at least two classes of the transmission component type depending on the detected vibrations.

According to the present disclosure, a quality check is carried out during production of a transmission component directly during the manufacture of the transmission component. The transmission component can belong to a transmission component type, for example can be a particular gearwheel, spur gear, ring gear, elements with hypoid gearing, as well as shafts, flanges, housings, or planetary carriers. At least one vibration sensor is mounted on the manufacturing machine, for example on a holder for the workpiece or on a holder for a tool of the manufacturing machine. A plurality of vibration sensors can also be arranged, in particular on different holders. The vibration sensors measure the vibrations during manufacture of the individual transmission component. The measurement result is reported, for example by way of a suitable electronic system, which can comprise an A/D converter, to a computer unit, with software installed thereon, which evaluates the measured vibrations. On the basis of the vibrations measured during manufacture, the manufactured transmission component is classified into suitable classes, in particular quality classes. These classes can include, for example, an iO class, for transmission components that are in order, and an NiO class, for transmission components that are not in order, that is to say that must be rejected. A more detailed classification into different quality classes can additionally be carried out. Depending on the determined class of the transmission component, the transmission component in question can correspondingly be managed further, for example stored at specific locations, installed in specific transmission devices and/or transmission positions, or discarded.

By way of this early quality determination by a vibration sensor, defective components can very quickly be discharged from the production process. Components of different quality grades can purposefully be used in different ways or in different transmission devices. Long-term damage and expensive repair works are avoided. The manufacturing process and the manufacturing machine can also be optimized as a result of the early monitoring.

A method according to the present disclosure can thus serve for quality assessment and prediction within the context of the production of a plurality of transmission components of a transmission component type.

The term “computer unit” can in each case include required software.

Further developments in accordance with the present disclosure are indicated throughout the present disclosure, the description, and the accompanying drawings.

Preferably, the individual transmission components, depending on the classification into a class of the transmission component type, are positioned at a predetermined storage location for this class. The components produced can thus be separated into quality classes, wherein the components of the different quality classes and different storage locations can be used further in different ways.

Preferably, the individual transmission components, depending on the classification into a class of the transmission component type, are installed in a predetermined transmission device type for the class. For example, higher-quality components can be used in a transmission of a higher-quality vehicle, and lower-quality components can be used in a transmission of a lower-quality, less expensive vehicle.

Preferably, depending on the evaluation of the detected vibrations by the software installed on the computer unit, an intervention is made in the machine controller, for example a PLC controller, of the manufacturing machine. For example, on the basis of the measured vibrations at the components currently being manufactured, the manufacturing process can be optimized by increasing various manufacturing process parameters, such as rotation speeds, feed rate, and thus the quality or speed of manufacture can be adapted dynamically by modifying the actuation of the manufacturing machine.

The classification of the transmission components by the computer unit in each case into one of at least two classes of the transmission component type depending on the detected vibrations can preferably be carried out depending on the vibration behavior at a predetermined vibration frequency, in particular depending on acceleration amplitude values at a predetermined vibration frequency. Thus, classification of the manufactured transmission components can preferably be carried out by evaluation of a single vibration frequency, or, for example, by evaluation of two or more vibration frequencies.

The detected vibrations and/or an evaluation of the detected vibrations by the computer unit can preferably be displayed on a display, at any desired human-machine interface (HMI). The manufacturing process can thereby be monitored by a user and optionally optimized by changing the controller of the manufacturing machine and/or individual transmission components can also be discarded or classified manually.

Preferably at least two or three vibration sensors are mounted on the manufacturing machine and/or further sensors, such as pressure, temperature or flow rate sensors, are mounted on the manufacturing machine, wherein properties—such as specific pressures, temperatures or flow rates—are detected by the sensors during manufacture of the transmission components in the manufacturing machine, wherein the detected properties are in each case evaluated by the computer unit, wherein the transmission components are in each case classified by the computer unit into one of the at least two classes of the transmission component type depending on all the properties. The classification of the transmission components can thus be carried out depending on the combined sensor results of at least two sensors, for example of at least two vibration sensors or one vibration sensor and one other type of sensor.

The vibration sensor, or plurality of vibration sensors, and sensors of other types can preferably be mounted in each case on a workpiece holder or on a tool holder, in particular on a spindle or a shaft, of the manufacturing machine. A plurality of sensors can be arranged on a plurality of holders, in particular on a plurality of spindles or shafts of a manufacturing machine, for example a sensor on a grinding spindle, a sensor on a workpiece spindle, and/or a sensor on a spindle of a dressing wheel.

An electronic unit is preferably provided between the vibration sensor and the computer unit, wherein at least an A/D conversion of the signals of the vibration sensor can be carried out by the electronic unit. The electronic unit can also serve for signal processing and/or signal transmission.

A vibration spectrum can preferably be stored and archived for each component, in order to obtain information about the general condition of the manufacturing machine, such as wear of guides, shafts and spindles. Any machine damage can thereby be detected and predicted in good time, which allows corresponding repair and maintenance measures to be planned and initiated in order to avoid machine downtimes and to increase and optimize machine utilization.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations and are not intended to limit the scope of the present disclosure.

The present disclosure will be described herein below by way of example with reference to the drawings.

FIG. 1 is a schematic representation of a method according to the invention.

FIG. 2 is a schematic representation of an evaluation in a computer unit within the context of a method according to the invention according to FIG. 1.

### DETAILED DESCRIPTION

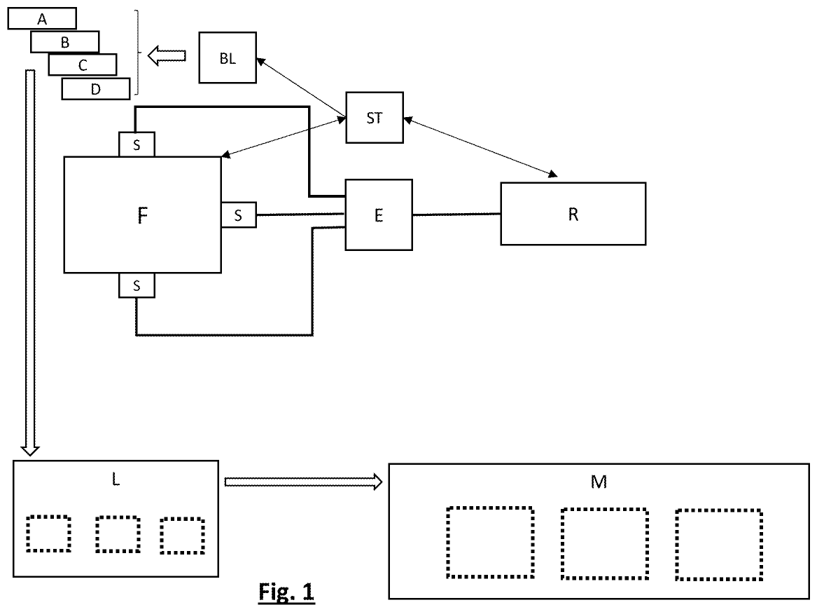

A method according to the present disclosure for producing a plurality of transmission components A, B, C, D of a transmission component type, for example of a gearwheel for a transmission, is shown schematically in FIG. 1.

The transmission components A, B, C, D are manufactured in a manufacturing machine F, wherein the manufacturing method can comprise in particular grinding processes. By way of example, three vibration sensors S are mounted on the manufacturing machine F, namely a vibration sensor S on each of a grinding spindle, a workpiece spindle, and a spindle of a dressing wheel of the manufacturing machine F.

By means of the vibration sensors S, vibrations during manufacture of the transmission components A, B, C, D in the manufacturing machine F, at the respective spindle or shaft, are detected.

The detected vibrations are evaluated by a computer unit R, more specifically by program logic (software) in the computer unit R, and the transmission components A, B, C, D are thereby in each case classified by the computer unit R into one of at least two classes of the transmission component type depending on the detected vibrations.

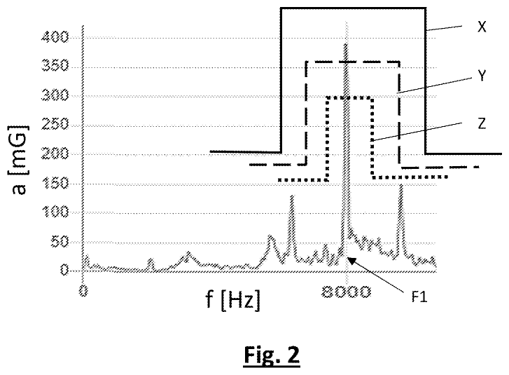

The evaluation by the computer unit R for classification of the transmission components A, B, C, D is shown in FIG. 2 and will be described in greater detail below with further reference to FIG. 2.

An electronic unit E is arranged between the vibration sensors S and the computer unit R, wherein an A/D conversion (analog/digital conversion) of the signals of the vibration sensor S and, optionally, further signal processing steps are carried out by the electronic unit E.

The computer unit R is also connected to a controller ST of the manufacturing machine F, for example to a PLC (programmable logic controller) for controlling the manufacturing machine, so that, depending on the evaluation of the detected vibrations by the computer unit R, an intervention can be made in the controller ST of the manufacturing machine F, for example a machine stop and/or a discharge of the detected component into an NiO component bin.

The detected vibrations and/or an evaluation of the detected vibrations by the computer unit R can be displayed to a user, for example, on a display.

The manufactured transmission components A, B, C, D are removed from the manufacturing machine F in a component loader/component unloader BL and, depending on the classification into a class of the transmission component type, in particular depending on a quality class, can be positioned at a predetermined storage location L for the class. Different storage locations for different classes of transmission components A, B, C, D are indicated in FIG. 1 by rectangles marked by dotted lines. Depending on the class of a transmission component A, B, C, D, the transmission component can also be rejected, for example, and not supplied to further processing.

Depending on the classification into a class of the transmission component type, the transmission component A, B, C, D can be installed in a mounting M in a predetermined transmission device type for the class, for example in a transmission of a particular vehicle type. Additionally, in the mounting M, different mounting possibilities in different transmission device types for different classes of transmission components A, B, C, D are indicated in FIG. 1 by rectangles marked by dotted lines.

With reference now to FIG. 2, an evaluation in a computer unit R within the context of an aspect of a method according to the present disclosure is shown schematically.

The vibrations at a vibration sensor S on the manufacturing machine F during processing of a transmission component A, B, C, D that are transmitted to the computer unit R are shown in a diagram, wherein the frequency in Hz is shown on the x-axis and the acceleration amplitude in milli-g, that is to say in thousandths of gravitational acceleration g, is shown on the y-axis. A similar diagram can be displayed, for example, to a user on a display of the computer unit R. Depending on the determined vibration spectrum during manufacture of the transmission component A, B, C, D, the respective transmission component A, B, C, D can be classified by the computer unit R into one of at least two classes of the transmission component type.

For example, the classification of the transmission components A, B, C, D by the computer unit R can be carried out depending on the vibration behavior or the vibration amplitude limit at a single predetermined vibration frequency F1—in the example of FIG. 2 the predetermined vibration frequency F1 for classification of the transmission components A, B, C, D is at 8000 Hz. The required frequency or frequencies for the classification thereby depend on various factors, such as the manufacturing machine F used, the manufactured transmission component type, the tool used, the current manufacturing process parameters, such as rotation speeds, feed rates, and the type and position of the vibration sensors S. The frequencies for classification of the transmission components A, B, C, D are therefore to be determined for each application.

Depending on the value of the acceleration “a” at the predetermined frequency F1, or at a plurality of predetermined frequencies, the transmission component A, B, C, D, where fixed limit values X, Y, Z are exceeded or where an acceleration value in a particular range is present, can be classified into a respective class and accordingly used further or rejected.

The vibration spectrum, which can also be stored and archived for each component, additionally provides information about the general condition of the manufacturing machine, such as wear of guides, shafts and spindles, whereby any machine damage can be detected and predicted in good time, which allows corresponding repair and maintenance measures to be planned and initiated in order to avoid machine downtimes and to increase and optimize machine utilization.

### LIST OF REFERENCE DESIGNATIONS

A, B, C, D transmission components
BL component loader/component unloader
E electronic module
F manufacturing machine
F1 predetermined vibration frequency
L storage location
M mounting
R computer unit
S vibration sensor
ST controller
X, Y, Z limit values

What is claimed is:

1. A method for producing a plurality of transmission components of a transmission component type, the method comprising the steps of:
manufacturing the transmission components in a manufacturing machine,
mounting at least one vibration sensor on the manufacturing machine,
detecting vibrations during manufacture of the transmission components in the manufacturing machine by the vibration sensor,
evaluating the detected vibrations in each case by a computer unit,
classifying the transmission components in each case by the computer unit into one of at least two classes of the transmission component type depending on the detected vibrations.

2. The method as claimed in claim 1,
wherein, depending on the classification into a class of the transmission component type, positioning the transmission components at a predetermined storage location for the class.

3. The method as claimed in claim 1,
wherein, depending on the classification into a class of the transmission component type, installing the transmission components in a predetermined transmission device type for the class.

4. The method as claimed in claim 1,
wherein, depending on the evaluation of the detected vibrations, performing an intervention in the controller of the manufacturing machine by the computer unit.

5. The method as claimed in claim 1,
wherein the classification of the transmission components by the computer unit in each case into one of at least two classes of the transmission component type depending on the detected vibrations is carried out depending on a vibration behavior at a predetermined vibration frequency or depending on a vibration behavior at a plurality of predetermined vibration frequencies.

6. The method as claimed in claim 1,
wherein the detected vibrations and/or an evaluation of the detected vibrations by the computer unit are displayed on a display.

7. The method as claimed in claim 1, further comprising:
mounting further sensors on the manufacturing machine, wherein the further sensors comprise at least one of pressure, temperature, or flow rate sensors,
detecting properties by the further sensors during manufacture of the transmission components in the manufacturing machine,
evaluating the properties detected by the further sensors in each case by the computer unit,
classifying the transmission components in each case by the computer unit into one of the at least two classes of the transmission component type depending on all of the detected and evaluated properties of the further sensors.

8. The method as claimed in claim 7,
wherein the at least one vibration sensor and/or at least one further sensor are mounted in each case on a holder.

9. The method as claimed in claim 1, wherein
an electronic unit is provided between the vibration sensor and the computer unit, wherein at least an A/D conversion of signals of the vibration sensor is carried out by the electronic unit

10. The method as claimed in claim 1, wherein
the detected vibrations are stored in the form of a vibration spectrum for each component, wherein a condition of the manufacturing machine is determined by a control routine or a user on the basis of the stored vibration spectra.

11. The method as claimed in claim 5, wherein the classification is carried out depending on acceleration amplitude values at a predetermined vibration frequency or at a plurality of predetermined vibration frequencies.

12. The method as claimed in claim 7, wherein at least two vibration sensors are mounted on the manufacturing machine.

13. The method as claimed in claim 7, wherein classification is carried out depending on combined sensor results of at least one vibration sensor and at least one further sensor.

14. The method as claimed in claim 1, wherein at least two vibration sensors are mounted on the manufacturing machine.

15. The method as claimed in claim 8, wherein the holder a spindle or shaft of the manufacturing machine.

16. The method as claimed in claim 8, wherein the at least one vibration sensor and/or the further sensors are arranged on different holders.

17. The method as claimed in claim 1, wherein the at least two classes comprises different quality classes including an in order class (IO) and a not in order class (NiO).

18. The method as claimed in claim 1 further comprising, on the basis of measured vibrations of the component being manufactured, increasing parameters of the manufacturing process, wherein the parameters include at least one of rotation speed or feed rate, such that quality or speed of the manufacturing process is adapted dynamically.
